(19) United States
(12) Patent Application Publication
(10) Pub. No.: US 2017/0223179 A1
(43) Pub. Date: Aug. 3, 2017

(54) MOBILE PHONE

(71) Applicant: KYOCERA Corporation, Kyoto (JP)

(72) Inventors: Saya MIURA, Yokohama-shi (JP); Kazuki MORITA, Tokyo (JP)

(73) Assignee: KYOCERA Corporation, Kyoto (JP)

(21) Appl. No.: 15/420,456

(22) Filed: Jan. 31, 2017

(30) Foreign Application Priority Data
Feb. 1, 2016 (JP) 2016-017280

(51) Int. Cl. H04M 1/725

(52) U.S. Cl. CPC H04M 1/72597; H04M 1/72583

(57) ABSTRACT

A mobile phone includes a display that displays a screen, and the mobile phone displays a lock screen on the display once a predetermined time elapses. When a phone call begins in a state of a lock on the lock screen being released, the mobile phone does not display the lock screen on the display even after the predetermined time elapses.

### TECHNICAL FIELD

This disclosure relates to a mobile phone. In greater detail, this disclosure relates to a mobile phone such as a smartphone or a feature phone.

### BACKGROUND

In many of the mobile phones such as smartphones that are currently being sold, a lock screen is displayed on a screen configured by a touch panel for example when the power is turned on, and operations other than a predetermined operation are invalid (locked state) (for example, see JP 2014-67247 A (PTL 1)).

### CITATION LIST

### Patent Literature

PTL 1: JP 2014-67247 A

### SUMMARY

A mobile phone according to this disclosure includes:

a display configured to display a screen; such that

the mobile phone displays a lock screen on the display once a predetermined time elapses; and

when a phone call begins in a state of a lock on the lock screen being released, the mobile phone does not display the lock screen on the display even after the predetermined time elapses.

Another mobile phone according to this disclosure includes:

a display configured to display a screen; such that

the mobile phone displays a lock screen on the display once a screen of the display turns on after having turned off; and

when a phone call begins in a state of a lock on the lock screen being released and the screen of the display turns on after having turned off during the phone call, the mobile phone does not display the lock screen on the display.

### BRIEF DESCRIPTION OF THE DRAWINGS

In the accompanying drawings:

FIG. 1 is an external view of a mobile phone according to Embodiment 1 of this disclosure;

FIG. 2 is a block diagram schematically illustrating the structure of a mobile phone according to Embodiment 1 of this disclosure;

FIG. 3 is a flowchart illustrating operations of a mobile phone according to Embodiment 1 of this disclosure;

FIGS. 4A to 4F illustrate operations of a mobile phone according to Embodiment 1 of this disclosure;

FIG. 5 is an external view of a mobile phone according to Embodiment 2 of this disclosure;

FIG. 6 is a block diagram schematically illustrating the structure of a mobile phone according to Embodiment 2 of this disclosure; and

FIG. 7 is a flowchart illustrating operations of a mobile phone according to Embodiment 2 of this disclosure.

### DETAILED DESCRIPTION

For reasons such as security and prevention of erroneous operation, some mobile phones such as feature phones that are currently being sold are also configured to display a lock screen for example when the power is turned on, or when the phone is opened from the folded state. On such a lock screen as well, operations other than limited, predetermined operations are typically invalid (locked state). In mobile phones that adopt a lock screen, the lock can be released (unlocked state) by performing a restricted predetermined operation in the locked state, and regular operations can then be performed. With the above-described mobile phones, if the lock screen is displayed after the end of a phone call even though the mobile phone was in the unlocked state at the start of the phone call, the user has to release the locked state, which is troublesome.

Therefore, it would be helpful to provide a mobile phone with improved usability.

According to this disclosure, the usability of a mobile phone can be improved.

The following describes an embodiment of this disclosure with reference to the drawings.

### Embodiment 1

In Embodiment 1 described below, a folding feature phone (flip phone or clamshell phone) is described as an example of a feature phone type mobile phone. Embodiments of this disclosure, however, are not limited to folding phones and may be another type of feature phone, such as a slide phone that is slid to reveal a keyboard, a bar phone (straight phone), or the like.

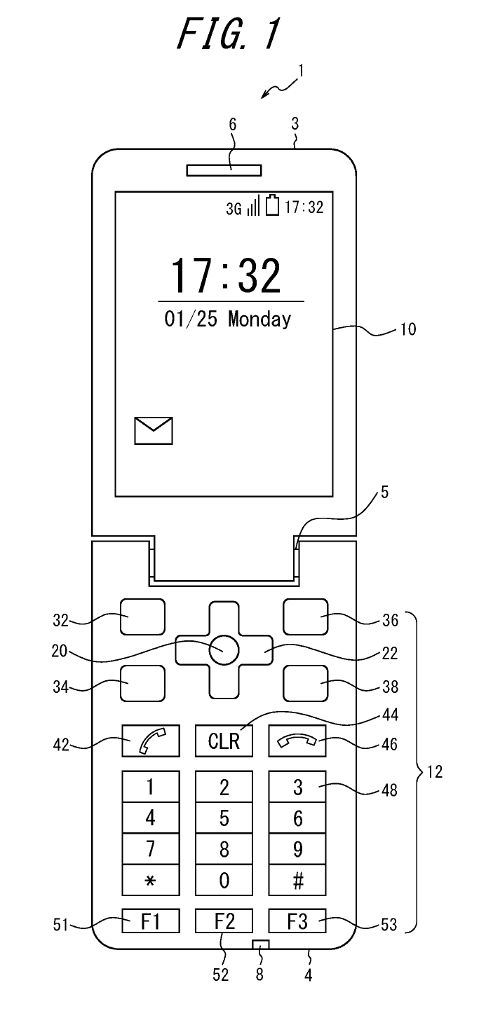

FIG. 1 is an external view of a mobile phone according to Embodiment 1 of this disclosure.

As illustrated in FIG. 1, the feature phone type mobile phone 1 according to this embodiment is a folding mobile phone in which an upper housing 3 and a lower housing 4 are connected by a hinge 5. In this mobile phone 1, the upper housing 3 and the lower housing 4 can, for example, be folded with the hinge 5 as the valley of the fold. Since the external structure of the mobile phone 1 can be similar to that of a well-known folding feature phone type mobile phone, a more detailed explanation is omitted.

As illustrated in FIG. 1, the mobile phone 1 includes a speaker 6 and display 10 on the upper housing 3 side. On the lower housing 4 side, the mobile phone 1 also includes a microphone 8 and a physical key section (keyboard) 12 configured by various types of physical keys. The speaker 6 outputs voice to the user's ear during a phone call, and the microphone 8 acquires voice emitted from the user's mouth during a phone call. Since the speaker 6 and the microphone 8 may be similar to those used in a typical mobile phone, a more detailed explanation is omitted. The physical key section 12 detects input of a press from the user who operates the mobile phone 1.

The display 10 is a display device such as a liquid crystal display, an organic EL display, an inorganic EL display, or the like. The display 10 may be provided with a light source or light-emitting element used as a backlight 11. The display 10 displays a variety of information to the user operating the mobile phone 1, such as characters, symbols, images, objects for operation (icons), and the like. In other words, in the mobile phone 1 according to this embodiment, the display 10 displays a screen.

The physical key section 12 includes a center key (enter key) 20, a direction key (cursor key) 22, a menu key 32, a mail key 34, a camera key 36, a web key 38, a talk key 42, a clear key 44, a hang-up/power key 46, numeric keys 48, and three function keys (first function key 51, second function key 52, and third function key 53). The numeric keys 48 include number keys from 0 to 9 and other symbol keys. The keys constituting the physical key section 12 may be configured as push-button type automatic return switches or the like. Since the functions of the keys constituting the physical key section 12 may be similar to those of a typical mobile phone, a more detailed explanation is omitted. In FIG. 1, the characters or symbols stamped on the key tops of the keys constituting the physical key section 12 are simplified or omitted as appropriate.

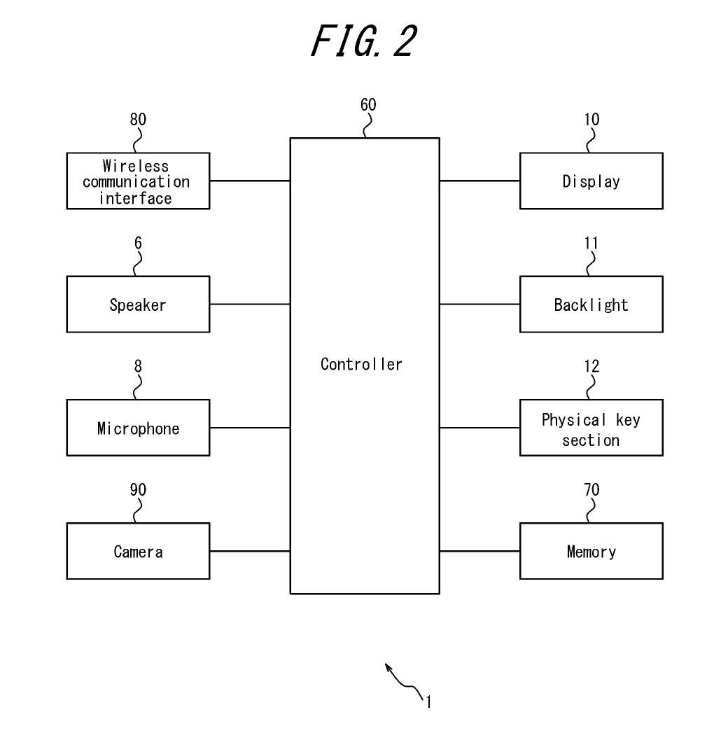

FIG. 2 is a block diagram schematically illustrating the structure of a mobile phone 1 according to one of the embodiments of this disclosure.

As illustrated in FIG. 2, in terms of functionality, the mobile phone 1 includes the display 10, the physical key section 12, and a controller 60. As described with reference to FIG. 1, the mobile phone 1 also includes the speaker 6 and the microphone 8 in order to implement the functions of a mobile phone. As illustrated in FIG. 2, the mobile phone 1 also includes a memory 70 and a wireless communication interface 80. As described above, the mobile phone 1 may for example include the backlight 11 that illuminates the display 10 from the back face thereof. Furthermore, the mobile phone 1 may include other components as appropriate, such as a camera 90 for capturing photographs or video.

The controller 60 may be configured by a processor that, starting with the functional blocks of the mobile phone 1, controls and manages the mobile phone 1 overall. The controller 60 may be a processor such as a CPU that executes a program prescribing control procedures. The program executed by the controller 60 may, for example, be stored in the memory 70, on an external storage medium, or the like.

The memory 70 may be configured by a storage apparatus such as a semiconductor memory. The memory 70 stores a variety of information, programs for causing the mobile phone 1 to operate, and the like and also functions as a working memory. The memory 70 may, for example, be configured to include RAM and ROM or the like. The memory 70 for example stores certain programs corresponding to applications to cause the controller 60 to execute particular functions, and also stores text data for e-mail, image data, and the like.

The wireless communication interface 80 for example connects to a communication network by wireless communication over an antenna with a wireless communication base station and executes functions for the mobile phone 1 to place a phone call, engage in data communication, and like. Since the wireless communication interface 80 can be configured similarly as the components for implementing the wireless communication function of a regular smartphone or feature phone, a more detailed explanation is omitted.

The camera 90 is a component for implementing the function of a digital camera that can capture still images or video. The data of the still images or video captured by the camera 90 may, for example, be saved in the memory 70. Since the camera 90 can be configured in a similar way as the camera provided in a regular smartphone or feature phone, a more detailed explanation is omitted.

Next, operations of the mobile phone 1 according to this embodiment are described.

By appropriately switching between the locked state and the unlocked state, the mobile phone 1 according to this embodiment has improved usability. In this context, the locked state refers to a state in which a lock screen is displayed on the display 10 and operations other than predetermined operations are invalid, as described above. The unlocked state refers to a state in which the lock in the locked state has been released, as described above.

Some feature phones that are now commercially available display the lock screen for example when the power is turned on, or when the phone is opened from the folded state, depending on the specifications or settings of the Operating System (OS). In such a locked state, operations other than predetermined operations are invalid, which has the advantages of heightening security and preventing erroneous operations.

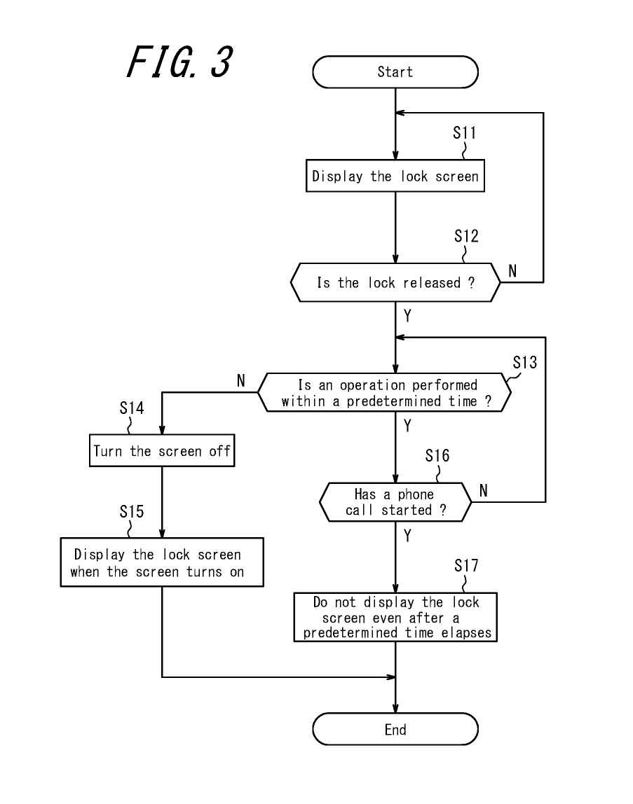

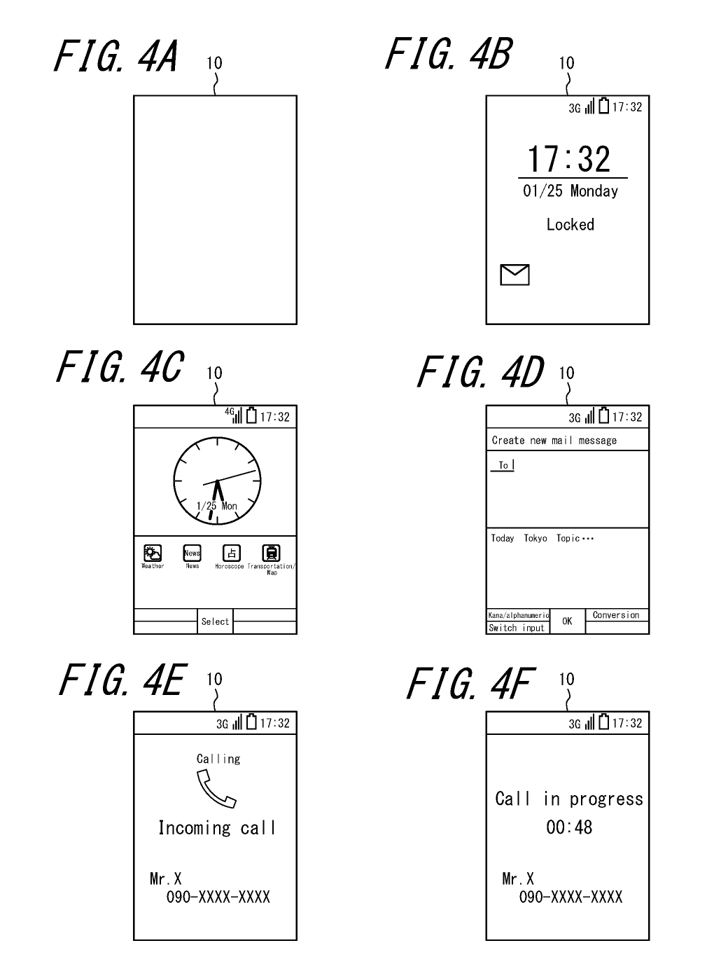

FIG. 3 is a flowchart illustrating operations of the mobile phone 1. FIGS. 4A to 4F illustrate an example of display of a screen on the display 10 of the mobile phone 1. As an example, the following explanation centers on a situation in which there is an incoming call while the user is inputting the text of an e-mail using the mobile phone 1.

The operations illustrated in FIG. 3 are envisioned as starting for example in a situation in which the screen of the display 10 turns on, after having been off, upon the power being turned on to the mobile phone 1, the mobile phone 1 being opened from a closed state, or the like. As used herein, stating that a screen is “on” or “off” refers to at least one of the view on the display 10 and the backlight 11 of the display 10 being on or off. FIG. 4A illustrates a state in which the screen of the display 10 in the mobile phone 1 is off.

From this state, when the operations illustrated in FIG. 3 start, and the screen of the display 10 in the mobile phone 1 turns on, the controller 60 of the mobile phone 1 displays the lock screen on the display 10 (step S11). FIG. 4B illustrates an example in which, from a state where the screen on the display 10 of the mobile phone 1 is off, the screen is turned on and the lock screen is displayed. As illustrated in FIG. 4B, the mobile phone 1 may be configured so that by detecting a passcode such as a predetermined number input by the user on the lock screen of the mobile phone 1, the lock on the lock screen can be released.

Once the lock screen is displayed in step S11, the controller 60 determines whether the lock on the lock screen has been released (step S12). When the lock is not released in step S12, the controller 60 returns to step S11, displays the lock screen, and waits for release of the lock. Conversely, when the lock is released in step S12, the controller 60 for example displays a home screen, such as the one illustrated in FIG. 4C, on the display 10.

Once the lock is released in step S12, the controller 60 determines whether an operation by the user is detected within a predetermined time (step S13). The “predetermined time” in step S13 is the time that is counted until returning to the display of the lock screen when there is no operation by the user and may be set appropriately to a time such as 10 seconds. In addition to being the time for determining whether an operation by the user is detected, this predetermined time may also be the time for determining whether a predetermined event is detected, such as an incoming call.

When operation by the user is not detected in a predetermined time in step S13, the controller 60 turns off the screen on the display 10 (step S14). Once the screen is turned off as illustrated in FIG. 4A in step S14, the controller 60 displays the lock screen on the display 10 when the screen is next turned on (step S15). After the processing in step S15, the processing illustrated in FIG. 3 terminates.

In this example, the case of an operation by the user being detected within the predetermined time as a result of the user inputting the text of a mail message on the mobile phone 1, as illustrated in FIG. 4D, is described. When an operation by the user is detected within the predetermined time in step S13, the controller 60 determines whether a phone call by the mobile phone 1 has started (step S16). In this context, the case of a phone call by the mobile phone 1 having started is envisioned as the case of an incoming call being received while the user is performing another operation, with a phone call starting in response to the incoming call. For example, while the user is performing an operation to input text of the mail message as illustrated in FIG. 4D, if an incoming call is received as illustrated in FIG. 4E, and a phone call starts in response to the incoming call, then the screen indicates that a call is in progress, as illustrated in FIG. 4F. The start of a phone call by the mobile phone 1 may also refer to the case of the user himself starting a phone call by performing an operation to place a phone call. For example, as illustrated in FIG. 4F, the user may start a phone call by inputting his own phone number or selecting the other party's phone number from an address book. There may be a variety of triggers for starting a phone call by the mobile phone 1, such as detection of input on the talk key 42, launching of a phone call application, establishment of a connection for a phone call, and the like.

When the start of the call is not detected in step S16, the controller 60 returns to step S13 and determines whether an operation by the user is detected within the predetermined time. On the other hand, when a phone call starts in step S16, the controller 60 does not display the lock screen on the display 10 even after the above-described predetermined time elapses (step S17). In other words, once the lock is released and the phone call begins, the mobile phone 1 according to this embodiment is configured not to display the lock screen illustrated in FIG. 4B on the display 10 even if the phone call ends after the predetermined time elapses.

When a screen for performing an operation to input text for a mail message was being displayed on the display 10 before the start of the phone call, the mobile phone 1 according to this embodiment preferably returns to the screen for performing an operation to input text for a mail message, for example as illustrated in FIG. 4D, without displaying the lock screen. With this approach, the user is spared the trouble of releasing the lock on the lock screen after the end of the phone call and can continue the operation that he was performing before the start of the phone call to input text for a mail message. As in step S13, the predetermined time in step S17 may be the time that is counted until returning to the display of the lock screen when there is no operation by the user.

In the above-described example, the “predetermined time” in step S13 and step S17 has been described as the time counted until displaying the lock screen in the case that no operation is performed or a predetermined event does not occur. The mobile phone 1 according to this embodiment may also set a time that is longer than this predetermined time, such as 30 seconds, and turn the screen off in the case that no operation is performed or a predetermined event does not occur until this time is counted.

As described above, the mobile phone 1 according to this embodiment displays a lock screen on the display 10 after a predetermined time elapses. However, when a phone call begins in the state of the lock on the lock screen being released, the mobile phone 1 according to this embodiment does not display the lock screen on the display 10 even after the predetermined time elapses. In this context, stating that “a phone call begins in the state of the lock on the lock screen being released” may refer to the case of an incoming call being received in the state of the lock on the lock screen being released and a phone call beginning in response to the incoming call.

When the screen of the display 10 is off after the predetermined time elapses, the mobile phone 1 according to this embodiment may display the lock screen when the screen of the display 10 turns on. In the mobile phone 1 according to this embodiment, when the screen of the display 10 turns on or off, at least one of the view on the display 10 and the backlight 11 of the display 10 may be turned on or off.

In this way, the mobile phone 1 according to this embodiment does not enter the locked state in a situation not intended by the user, and the user is spared the trouble of releasing the locked state. Therefore, the mobile phone 1 according to this embodiment can suitably switch between the locked state and the unlocked state and improves the usability of the mobile phone.

### Embodiment 2

The following describes Embodiment 2 of this disclosure. In Embodiment 2 of this disclosure, a smartphone type mobile phone is described as an example.

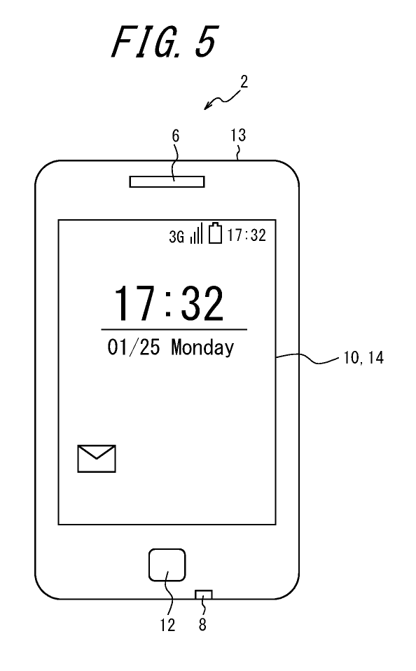

FIG. 5 is an external view of a mobile phone according to Embodiment 2 of this disclosure.

As illustrated in FIG. 5, a smartphone type mobile phone 2 according to this embodiment includes a housing 13 and a display 10. Since the external structure of the mobile phone 2 as well can be similar to that of a well-known smartphone type mobile phone, a more detailed explanation is omitted.

As illustrated in FIG. 5, the mobile phone 2 includes a speaker 6, a microphone 8, and the display 10 in the housing 13. In the mobile phone 2 according to this embodiment, the display 10 preferably includes a touch sensor 14, on the surface side of the display 10, that detects a touch operation by the user. In the housing 13, the mobile phone 2 also includes a physical key section 12 configured by one or more physical keys. The speaker 6, microphone 8, and display 10 may be similar in structure to the above-described Embodiment 1, and since these components may be similar to those used in a typical mobile phone, a more detailed explanation is omitted.

The touch sensor 14 can be any of a variety of types, such as a resistive film type, a capacitive type, or an optical type. On a smartphone type mobile phone, numeric keys or other such keys, icons, or the like can be displayed on the display 10 as objects, and the touch sensor 14 can detect an operation by the operator to contact the objects. Since the touch sensor 14 and the display 10 provided with the touch sensor 14 may also have a similar structure to that of components used in well-known smartphones, a more detailed explanation is omitted.

The physical key section 12 detects input of a press from the user who operates the mobile phone 2. The physical key section 12 may be configured to include one key or any other number of keys. When the mobile phone 2 includes the touch sensor 14, for example dial keys (numeric keys) used when placing a phone call can be detected with the touch sensor 14 by detecting user operation to contact keys displayed as images on the display 10. Accordingly, a smartphone such as the mobile phone 2 according to this embodiment may be configured with fewer physical keys than the various keys constituting the physical key section 12 of the mobile phone 1 according to Embodiment 1.

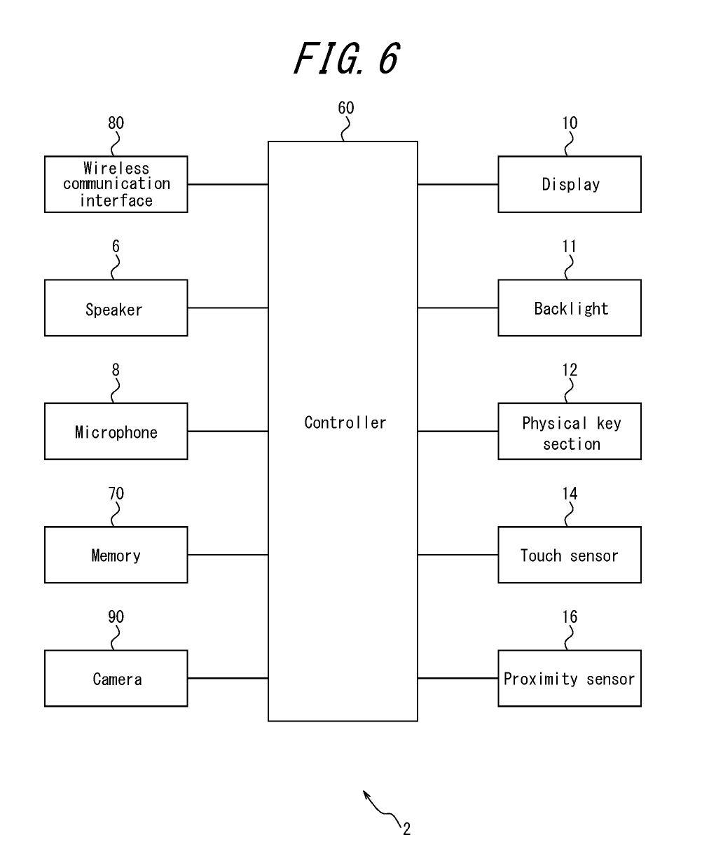

FIG. 6 is a block diagram schematically illustrating the structure of the mobile phone 2 according to one of the embodiments of this disclosure.

As illustrated in FIG. 6, in terms of functionality, the mobile phone 2 includes the display 10, the physical key section 12, the touch sensor 14, and a controller 60. As described with reference to FIG. 5, the mobile phone 2 also includes the speaker 6 and the microphone 8 in order to implement the functions of a mobile phone. As illustrated in FIG. 6, the mobile phone 1 also includes a memory 70 and a wireless communication interface 80. The mobile phone 2 may for example include a backlight 11 that illuminates the display 10 from the back face thereof. Furthermore, the mobile phone 1 may include other components as appropriate, such as a camera 90 for capturing photographs or video. As illustrated in FIG. 6, the mobile phone 2 may also include a proximity sensor 16.

The controller 60, memory 70, wireless communication interface 80, and camera 90 may be similar in structure to the above-described Embodiment 1, and since these components may be similar to those used in a typical mobile phone, a more detailed explanation is omitted.

The proximity sensor 16 detects the proximity of an object to the housing surface or the like of the mobile phone 2. In the mobile phone 2 according to this embodiment, the proximity sensor 16 can detect that the user has placed an ear near the body of the mobile phone 2, for example during a phone call. Based on detection by the proximity sensor 16, the mobile phone 2 according to this embodiment for example can turn off the screen on the display 10 and/or invalidate the touch sensor 14 during a phone call. In other words, the mobile phone 2 according to this embodiment may turn the screen of the display 10 on or off based on the degree of proximity detected by the proximity sensor 16.

Next, operations of the mobile phone 2 according to this embodiment are described.

Like the mobile phone 1 according to Embodiment 1, by appropriately switching between the locked state and the unlocked state, the mobile phone 2 according to this embodiment has improved usability. Below, explanation of matter similar to the above-described mobile phone 1 according to Embodiment 1 is simplified or omitted as appropriate.

Some smartphones that are now commercially available display the lock screen, for example when the power or the screen is turned on, depending on the specifications or settings of the Operating System (OS). For reasons such as saving battery power, some of these smartphones turn the screen off when a predetermined time elapses after the lock is released and the unlocked state is entered. In this context as well, stating that a screen is “on” or “off” refers to at least one of the view on the display 10 and the backlight 11 of the display 10 being on or off.

For example, after the locked state is released and the unlocked state is entered, some smartphones turn the screen off when a predetermined event does not occur, such as no user operation being performed for a predetermined time such as 10 seconds. With these specifications or settings, the user needs to turn the screen on in order to continue operation once the screen has turned off after the predetermined time. Once the user turns the screen on, the lock screen is displayed. Hence, the user has to go to the trouble of releasing the locked state, which causes the user stress.

Therefore, in this embodiment, after the predetermined time, such as 10 seconds, elapses and the screen turns off, control is performed so as not to return to the locked state when the screen turns on in cases in which it is envisioned that the user does not wish to return to the locked state. In other words, when the screen of the display 10 turns off and then turns on, the mobile phone 2 according to this embodiment displays the lock screen on the display 10 as a general rule. In predetermined exceptional cases, however, the mobile phone 2 according to this embodiment performs control so as not to display the lock screen on the display 10 when the screen of the display 10 turns off and then turns on.

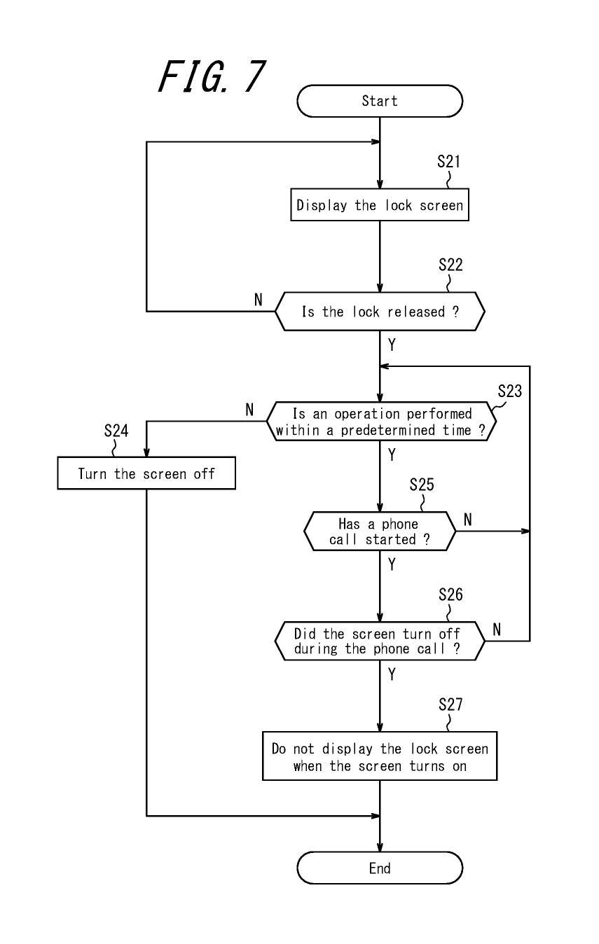

FIG. 7 is a flowchart illustrating operations of the mobile phone 2. As an example, the following explanation centers on a situation in which there is an incoming call while the user is inputting the text of an e-mail using the mobile phone 2.

The operations illustrated in FIG. 7 are envisioned as starting for example in a situation in which the screen of the display 10 turns on, after having being off, upon the power being turned on to the mobile phone 2, the screen being turning on, or the like. Many smartphones such as the mobile phone 2 for example have specifications such that, by detecting an operation by the user to press the physical key section 12, the screen can be turned on from a sleep state in which the screen is off. FIG. 4A illustrates a state in which the screen of the display 10 in the mobile phone 2 is off.

From this state, when the operations illustrated in FIG. 7 start, and the screen of the display 10 in the mobile phone 2 turns on, the controller 60 of the mobile phone 2 displays the lock screen on the display 10 (step S21). FIG. 4B illustrates an example in which, from a state where the screen on the display 10 of the mobile phone 2 is off, the screen is turned on and the lock screen is displayed. As illustrated in FIG. 4B, many mobile phones adopt specifications such that by detecting a slide operation by the user at a predetermined position on the lock screen of the mobile phone 2, or by detecting a passcode such as a predetermined number input by the user, the lock can be released.

Once the lock screen is displayed in step S21, the controller 60 determines whether the lock on the lock screen has been released (step S22). When the lock is not released in step S22, the controller 60 returns to step S21, displays the lock screen, and waits for release of the lock. Conversely, when the lock is released in step S22, the controller 60 for example displays a home screen, such as the one illustrated in FIG. 4C, on the display 10.

Once the lock is released in step S22, the controller 60 determines whether an operation by the user is detected within a predetermined time (step S23). The “predetermined time” in step S23 is the time after which the screen is turned off when there is no operation by the user. This time may be set appropriately to a time such as 10 seconds. In addition to being the time for determining whether an operation by the user is detected, this predetermined time may also be the time for determining whether a predetermined event is detected, such as an incoming call.

When operation by the user is not detected in a predetermined time in step S23, the controller 60 turns off the screen on the display 10 (step S24). In this case, the display 10 of the mobile phone 2 is turned off, for example as illustrated in FIG. 4A. Once the screen turns off in step S24, the processing illustrated in FIG. 7 terminates, and when the user turns the screen on again, the controller 60 begins the processing in FIG. 7 again. In other words, once the screen turns off in step S24, the display 10 displays the lock screen, such as the one illustrated in FIG. 4B, the next time the user turns the screen on (step S21).

In this example, the case of an operation by the user being detected within the predetermined time as a result of the user inputting the text of a mail message on the mobile phone 2, as illustrated in FIG. 4D, is described. When an operation by the user is detected within the predetermined time in step S23, the controller 60 determines whether a phone call by the mobile phone 2 has started (step S25). Here as well, the case of a phone call by the mobile phone 2 having started includes the case of an incoming call being received while the user is performing another operation, with a phone call starting in response to the incoming call, and may also include the case of the user himself starting a phone call by performing an operation to place a call. There may be a variety of triggers for starting a phone call by the mobile phone 2, such as detection of an operation by the user to start a phone call, launching of a phone call application, establishment of a connection for a phone call, and the like.

When the start of the call is not detected in step S25, the controller 60 returns to step S23 and determines whether an operation by the user is detected within the predetermined time. On the other hand, when a phone call starts in step S25, the controller 60 determines whether the screen turned off during the phone call (step S26). The case of the screen turning off during the phone call in step S26 is, for example, envisioned as the case of the proximity sensor 16 detecting that the user has placed an ear near the mobile phone 2 during the phone call and the controller 60 then turning off the screen on the display 10, as described above. The case of the screen turning off during the phone call in step S26 may, for example, also be envisioned as the case of user operation not being detected within a predetermined time during the phone call and the controller 60 then turning off the screen on the display 10.

When the screen does not turn off during the phone call in step S26, the controller 60 returns to step S23 and determines whether an operation by the user is detected within the predetermined time. On the other hand, when the screen has turned off during the phone call in step S26, the controller 60 is configured not to display the lock screen on the display 10 when the screen turns on next (step S27). In other words, once the lock is released and the phone call begins, the mobile phone 2 according to this embodiment is configured so that after the screen turns off, the lock screen illustrated in FIG. 4B is not displayed on the display 10 when the screen turns back on.

The trigger for the screen to turn on can, for example, be a time at which the phone call can be determined to have ended, such as when the proximity sensor 16 detects that the user has withdrawn the ear from the mobile phone 2. The trigger for the screen turning on may also be a variety of other times at which the phone call can be considered to have ended, such as when the phone call application terminates operations, or when the connection for the phone call is cut. The trigger for the screen turning on may also, for example, be a variety of other times, such as when user operation is detected on the physical key section 12, on a predetermined position of the touch sensor 14, or the like.

When a screen for performing an operation to input text for a mail message was being displayed on the display 10 before the start of the phone call, the mobile phone 2 according to this embodiment is preferably configured to return to the screen for performing an operation to input text for a mail message, for example as illustrated in FIG. 4D, when the screen turns on. With this approach, the user is spared the trouble of releasing the lock on the lock screen after the end of the phone call and can continue the operation that he was performing before the start of the phone call to input text for a mail message.

As explained above, when the screen of the display 10 turns off and then turns on, the mobile phone 2 according to this embodiment displays the lock screen on the display 10. However, when a phone call begins in the state of the lock on the lock screen being released, then after the screen on the display 10 turns off during the phone call, the mobile phone 2 according to this embodiment does not display the lock screen on the display 10 when the screen of the display 10 turns back on. In this context, stating that “a phone call begins in the state of the lock on the lock screen being released” may refer to the case of an incoming call being received in the state of the lock on the lock screen being released and a phone call beginning in response to the incoming call.

In the mobile phone 2 according to this embodiment as well, when the screen of the display 10 is turned on or off, at least one of the view on the display 10 and the backlight 11 of the display 10 may be turned on or off.

In this way, the mobile phone 2 according to this embodiment does not enter the locked state in a situation not intended by the user, and the user is spared the trouble of releasing the locked state. Therefore, the mobile phone 2 according to this embodiment can suitably switch between the locked state and the unlocked state and improves the usability of the mobile phone.

Although this disclosure is based on embodiments and drawings, it is to be noted that various changes and modifications will be apparent to those skilled in the art based on this disclosure. Therefore, such changes and modifications are to be understood as included within the scope of this disclosure. For example, the functions and the like included in the various functional components, means, and steps may be reordered in any logically consistent way. Furthermore, functional components or steps may be combined into one or divided. The above embodiments of this disclosure are not limited to being implemented precisely as described and may be implemented by combining or partially omitting the features thereof.

1. A mobile phone comprising:
a display configured to display a screen; wherein
the mobile phone displays a lock screen on the display once a predetermined time elapses; and
when a phone call begins in a state of a lock on the lock screen being released, the mobile phone does not display the lock screen on the display even after the predetermined time elapses.

2. The mobile phone of claim 1, wherein when an incoming call is received in a state of the lock on the lock screen being released, and a phone call begins in response to the incoming call, the mobile phone does not display the lock screen on the display even after the predetermined time elapses.

3. The mobile phone of claim 1, wherein when a screen of the display is off after the predetermined time elapses, the mobile phone displays the lock screen once the screen of the display turns on.

4. The mobile phone of claim 3, wherein the mobile phone turns at least one of a view on the display and a backlight of the display on or off when the screen of the display turns on or off.

5. A mobile phone comprising:
a display configured to display a screen; wherein
the mobile phone displays a lock screen on the display once a screen of the display turns on after having turned off; and
when a phone call begins in a state of a lock on the lock screen being released and the screen of the display turns on after having turned off during the phone call, the mobile phone does not display the lock screen on the display.

6. The mobile phone of claim 5, wherein when an incoming call is received in a state of the lock on the lock screen being released, a phone call begins in response to the incoming call, and the screen of the display turns on after having turned off during the phone call, the mobile phone does not display the lock screen on the display.

7. The mobile phone of claim 5, further comprising:
a proximity sensor; wherein
the mobile phone turns the screen of the display on or off based on a degree of proximity detected by the proximity sensor.

8. The mobile phone of claim 5, wherein the mobile phone turns at least one of a view on the display and a backlight of the display on or off when the screen of the display turns on or off.
